(19) United States
(12) Patent Application Publication
(10) Pub. No.: US 2006/0176193 A1
(43) Pub. Date: Aug. 10, 2006

(54) Marine vessel monitoring and communications system and method

(75) Inventor: Richard G. Wraight, Norwich, CT (US)

Correspondence Address: LAW OFFICE OF MICHAEL A. BLAKE, 112 BROAD STREET, MILFORD, CT, 06460, US

(73) Assignee: Thomas G. Faria Corporation

(21) Appl. No.: 11/249,704

(22) Filed: Oct. 13, 2005

Related U.S. Application Data
(60) Provisional application No. 60/645,961, filed on Jan. 24, 2005.

(51) Int. Cl. G08B 23/00; B60Q 1/00; G08B 1/00; G08B 13/00; G08G 1/123

(52) U.S. Cl. 340/984; 340/531; 340/988; 340/438; 340/574

(57) ABSTRACT

A system for monitoring conditions of a marine vessel, the system comprising: a monitoring enclosure; the monitoring enclosure comprising: a monitoring device circuit board; a cell phone module in communication with the monitoring device circuit board; a GPS receiver in communication with the monitoring device circuit board, and the cell phone module; a satellite modem in communication with the monitoring device circuit board, the GPS receiver, and the cell phone module; a bus input in communication with the monitoring device circuit board, and configurable to be in communication with a marine vessel data bus; and where the monitoring enclosure is configurable to be in communication with an internet and provide marine vessel operating conditions to a website. A method for transmitting operating conditions of a marine vessel. The method comprises: collecting data from a data bus or other inputs; determining whether a cellular network is available; transmitting data to a website via the cellular network, if it is determined that a cellular network is available; and transmitting data to a website via a satellite network, if it is determined that a cellular network is not available. A system for monitoring conditions of a marine vessel. The system comprises: a marine vessel data bus; a monitoring enclosure located on the marine vessel and in communication with the marine vessel data bus and other inputs; an internet in communication with the monitoring enclosure; a website in communication with the internet, configured to store data from the monitoring enclosure; and where the monitoring enclosure is in communication with the internet via a means selected from the group comprising a cellular network and a satellite network.

### CROSS-REFERENCES

The present application claims the benefit of provisional patent application No. 60/645,961, filed on Jan. 24, 2005 by Richard G. Wraight.

### TECHNICAL FIELD

The present invention pertains to information systems and in particular to a marine vessel monitoring and communications system.

### BACKGROUND

Current consumer demand for mobility in lifestyle and vacations has resulted in an increased popularity in marine vessels. However, most of the time, valuable marine vessels are left unattended on moorings or at docks leaving absentee boat owners to worry about the security of their unattended property. Absentee boat owners are also concerned about the vulnerability of their marine vessels to the elements and the malfunctioning of on-board equipment. This has created a substantial need for reliable, effective and affordable marine vessel monitoring systems which provide absentee boat owners with periodic reports on the condition of their unattended marine vessels. Accordingly, a number of marine vessel monitoring systems have been developed.

One particularly hazardous marine vessel condition that can give rise to substantial marine vessel damage relates to a marine vessel's bilge pump system. Bilge pump systems are critical to the maintenance of the proper level of the marine vessel within a body of water and include a water pump, a floating device to determine water level and a power source such as a battery. If the fuse is blown or the battery level is low, then a high water level can occur in the bilge causing substantial damage to the operation of the marine vessel. In addition, many bilge pump systems include a bilge pump circuit breaker which can be inadvertently turned off, which can also result in substantial damage to the marine vessel. If bilge pump conditions such as a blown fuse or low battery level can be detected in advance, then hazardous high water levels can be prevented.

Also, due to the large investment in today's marine vessels equipment, maintaining a log of engine conditions, engine run time, and other marine vessels conditions has become important for preventing and diagnosing marine vessels equipment malfunctions. However, there is no automated centralized system for doing so.

Accordingly, there is a need for a remote marine vessel monitoring system and method that allows a boat owner to monitor various on-board conditions associated with their marine vessel, to predict and avert potentially hazardous conditions. There is also a need for monitoring marine vessels conditions such as engine run time, engine operating conditions, accessory conditions, marine vessel location, and distance traveled by the marine vessel.

### SUMMARY

The disclosed system relates to monitoring conditions of a marine vessel, the system comprising: a monitoring enclosure; the monitoring enclosure comprising: a monitoring device circuit board; a cell phone module in communication with the monitoring device circuit board; a GPS receiver in communication with the monitoring device circuit board, and the cell phone module; a satellite modem in communication with the monitoring device circuit board, the GPS receiver, and the cell phone module; a bus input in communication with the monitoring device circuit board, and configurable to be in communication with a marine vessel data bus; and where the monitoring enclosure is configurable to be in communication with an internet and provide marine vessel operating conditions to a website.

The disclosed method relates to transmitting operating conditions of a marine vessel. The method comprises: collecting data from a data bus; determining whether a cellular network is available; transmitting data to a website via the cellular network, if it is determined that a cellular network is available; and transmitting data to a website via a satellite network, if it is determined that a cellular network is not available.

The disclosed system also relates to monitoring conditions of a marine vessel. The system comprises: a marine vessel data bus; a monitoring enclosure located on the marine vessel and in communication with the marine vessel data bus; an internet in communication with the monitoring enclosure; a website in communication with the internet, configured to store data from the monitoring enclosure; and where the monitoring enclosure is in communication with the internet via a means selected from the group comprising a cellular network and a satellite network.

### BRIEF DESCRIPTION OF THE DRAWINGS

The present disclosure will be better understood by those skilled in the pertinent art by referencing the accompanying drawings, where like elements are numbered alike in the several figures, in which:

FIG. 1 is a schematic diagram of one embodiment of the disclosed marine vessel monitoring system;

FIG. 2 is a schematic diagram of another embodiment of the disclosed system; and

FIG. 3 is a flowchart illustrating one embodiment of the disclosed method.

### DETAILED DESCRIPTION

The disclosed marine vessel monitoring system uses a GPS, to allow a user to know the position of a marine vessel, whether the marine vessel goes drifting due to a navigation error, or because a line broke, or under someone else's power. The disclosed system uses both cell phone modem and satellite modem techniques to communicate the condition of the vessel and/or position of the vessel. If communications are not established with a cell phone modem, then the satellite modem techniques are used. Both the satellite network and cell phone network can provide messages to user or a third party, such as security personnel, advising him or her of the status of any of the various signals that are monitored.

Engine data may be monitored in an external monitoring system such as, but not limited to the Faria Marine Instruments MG2000 bus, Faria Marine Instruments Gateway bus, and the Faria Marine Instruments Helmsman™ bus. The engine data is sent to the disclosed marine vessel monitoring system. Data may include engine control unit information, operational information, analog, digital and mechanical inputs, etc. Diagnostic data may be monitored with the disclosed marine vessel monitoring system. The monitored data can be sent by the various modems to an internet database. A database may be set up for any manufacturer, such as an engine manufacturer, marine vessel manufacturer, recreational vehicle manufacturer etc. A manufacturer may retrieve data from the database by accessing a website. Alternatively, the data may be sent directly to the manufacturer.

Switch inputs may also be monitored with the marine vessel monitoring system. Such switch inputs include but are not limited to: intrusion switches, door switch, and bilge pump switch. The disclosed marine vessel monitoring system can be configured to indicate whether a switch is normally opened or normally closed. The disclosed system monitors current to determine the status of the bilge pump. Using current obviates need of voltage monitoring devices to determine whether fuses are blown or not. If current is flowing to bilge pump, one can be sure the bilge pump is running, or if current keeps on running, you either have a short, or the marine vessel is sinking.

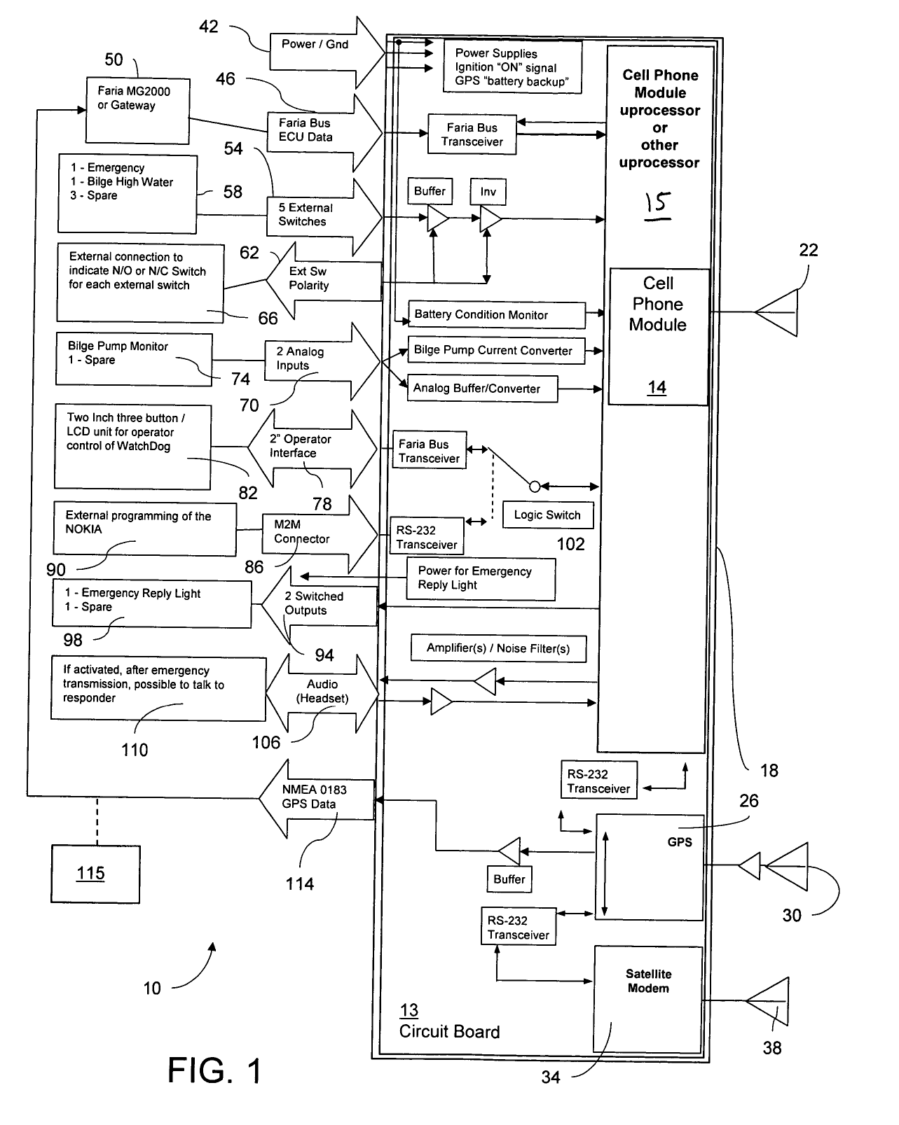

FIG. 1 shows a schematic view of one embodiment of the disclosed marine vessel monitoring system 10. A monitoring device circuit board 13 is located inside a monitoring enclosure 18. The enclosure 18 may comprise a box configured for marine use, and therefore be waterproof and/or weatherproof. In one disclosed embodiment the computing power of a cell phone module 14 in communication with the circuit board 13 may be used to perform the required computing functions. It is understood that a general purpose multi-port microcontroller such as the Microchip PIC18F6520 or Freescale “ColdFire” MCF5216 could be used in a similar fashion. The cell phone module 14 may be obtained from any of a number of manufacturers of cell phones, including but not limited to Nokia, Kyocera, Motorola, NEC, Sanyo, Sony-Ericsson, and Siemens. Additionally, in other embodiments, an entire cell phone may be located in the enclosure 18, rather than just the cell phone module 14. The cell phone module 14 is in communication with an antenna 22. The cell phone module 14 is also in communication with a global positioning system receiver 26 either directly or via the additional microprocessor. The global positioning receiver 26 may be any of a number of receivers, including but not limited to: u-blox; Garmin International; Lowrance, Eagle; Magellan, Thales; and SiRF. A global positioning system may also be included in the cell phone module 14 or the satellite modem. The global positioning receiver 26 is also in communication with an antenna 30. The global positioning receiver is in communication with a satellite modem 34 either directly or via the additional microprocessor. The satellite modem 34 may be selected from any number of available satellite modems, including but not limited to: Quake Global; Comtech EF Data; Datum Systems; Hughes Network Systems; Newtec; Paradise Datacom; Radyne ComStream; Shiron Satellite Communications; AdvantechAMT (formerly Signal Processors, SPL/ACT, ACT Wireless); Stella, and TSI Technology. The satellite modem 34 is also in communication with an antenna 38.

The monitoring enclosure 18 has a plurality of inputs, outputs, and interfaces. A power/ground input 42 provides power to the monitoring enclosure 18 and components within the enclosure 18. A serial bus input 46 is configured to couple to a data bus interface 50 for the marine vessel. The bus input 46 is in communication with the monitoring device circuit board 13 and the cell phone module 14 or additional microprocessor. The data bus interface 50 may include communication with an engine control unit for the marine vessel. In other embodiments, the bus input interface 46 may be a specialized data buse interface such as, but not limited to: Faria Marine Instruments MG2000 bus, Faria Marine Instruments Gateway bus, and the Faria Marine Instruments Helmsman™ bus. A multi-switch input 54 is coupled to the enclosure 18. The multi-switch input 54 may be configured to have as few as one switched input, and up to as many as 5 or more switched inputs. In one embodiment, the multi-switch input 54 may be configured to be in communication with the following switches 58: an emergency notification switch, a bilge high water switch, and three additional switches. The three additional switches may be in communication with user selected switches. The three additional switches may be used for, but not limited to: a shore power monitor via a set of relay contacts; entry detection switches (similar to known window/door magnetic switches used in a home alarm); intrusion detection devices using a light beam, laser beam, or motion sensor system to provide a switch closure, etc. The monitoring enclosure 18 may also have external switch polarity inputs 62. The external switch polarity inputs 62 are used to by the owner, for example, of the vessel, to indicate to the unit whether each external switch input is “normally on” or “normally off” at the multi-switch input 54. Three analog inputs 70 are coupled to the enclosure 18. The analog inputs 70 are configurable to couple the cell phone module 14 or additional microprocessor with one or more monitoring devices 74. In one disclosed embodiment, the monitoring devices 74 comprise a bilge pump monitor and a spare. The additional analog input, coupled to the system battery, may be configured to monitor the battery voltage to provide a warning of low battery voltage. An operator interface 78 is coupled to the enclosure 18. The operator interface 78 is configurable to allow the monitoring device circuit board 13 to be in communication with operator control unit 82. The operator control unit 82 may comprise a two inch three button LCD unit for operator control of the vehicle monitoring system 10. Of course, other known operator interfaces may be used at operator control unit 82; such interfaces include but are not limited to: keyboard and monitor; keyboard, monitor and mouse, and a touch screen. The operator control unit 82 may be configured to display marine vessel operation information and alarm information. A programming input 86 may be coupled to the enclosure 18. The programming input 86 is configurable to allow for external programming 90 to be inputted into the cell phone module 14 or additional microprocessors. The programming input 86 may be an M2M connector, but the vehicle monitoring system may be configured for other programming inputs. A switched output 94 is coupled to the enclosure 18. The switched output 94 is configurable to provide communication between the cell phone module 14 or additional microprocessor and a display or other device which can be switched, such as a horn or alarm 98. The switch output 94 may comprise one or more switched outputs. The display 98 may be configured to activate as an “Emergency Reply” indicator, and have a spare indicator. The “Emergency Reply” indicator may be configured to provide an indication that an emergency signal initiated by the emergency notification switch, discussed with switches 58 above, was successfully received. This is an improvement over prior art systems which only indicate that an emergency signal was not properly transmitted. Thus, in the prior art systems, one may be assured that an emergency was properly transmitted, however, this is not indicative of that emergency signal being received by someone who may act upon it. A power supply 102 may be located in the enclosure 18, and be in communication with the display 98, to provide power for the display 98. An audio input/output 106 may be coupled to the enclosure 18. The audio interface 106 is configured to provide communication between the cell phone module 14, the monitoring device circuit board 13 and a communication device 110. The communication device 110 may be a headset/microphone apparatus, or speaker/microphone hand held unit, or any other communication device currently in use. A GPS data output 114 is coupled to the enclosure 18. The GPS data output 114 is configurable to provide communication between a remote display unit 115 and the global positioning receiver 26. In one embodiment the display unit could be the Faria MG2000 system. Other display devices, configured for NMEA0183 input may be used. In another embodiment, a bus connection is provided to allow a manufacturer or other party may send data to the vehicle/vessel to update features or programming on addressable devices on the vehicle bus. The cell phone module may be used to call a preprogrammed number thereby allowing a user on the marine vessel to talk via the cell phone module 14, to a predetermined recipient.

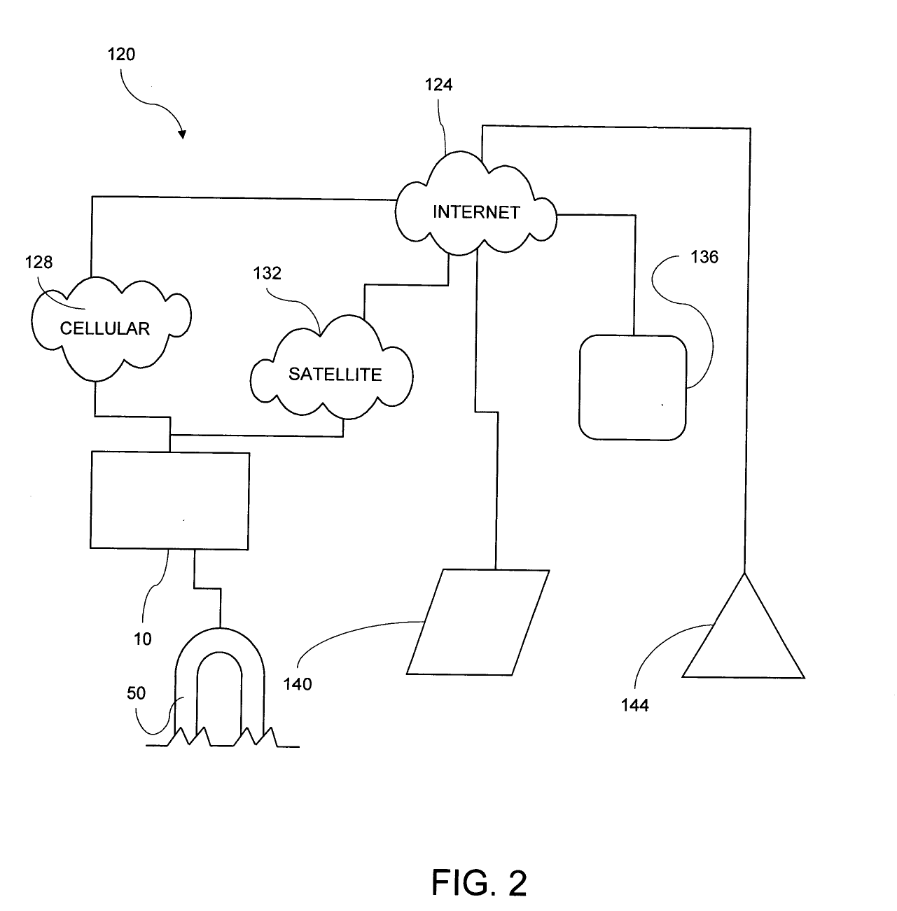

FIG. 2 is a schematic of a monitoring and communications system 120. The system comprises the marine vessel monitoring system 10 from FIG. 1. The marine vessel monitoring system 10 is in communication with an internet 124 via either a cellular network 128 or a satellite network 132. The marine vehicle monitoring system 10 is also in communication with a data bus 50. If the cellular network is not available to the marine vessel monitoring system 10, then the marine vessel monitoring system 10 can use the satellite network 132 to communicate with the internet 124. Information from the marine vessel monitoring system may be communicated through the internet 124 to a website 136. The website 136 may provide data for each marine vessel, and components of the marine vessel. Such data may include location, current status, alarm status, engine control unit data, voltage level of the primary battery, voltage level of the secondary battery, integrity of the bilge pump, activity of a first bilge pump, activity of a second bilge pump, and water level in the bilge. Therefore a user 140, such as a boat owner may access the website 136 via the internet 124, to check the status of his marine vessels, and components thereon. Additionally, the website 136 may provide manufacturer data for a particular piece of manufacturer's vehicle bus connected equipment, including, but not limited to: engines, pumps, hulls, vessels. For example, if 300 marine vessels have engines by a particular manufacturer and are equipped with the marine vessel monitoring device 10, the data for all 300 engines may be tabulated or otherwise available on the website 136 to allow a manufacturer 144 to analyze the data from all 300 engines. It should be understood that while alarm and operation information can be provided to a user 140 via the internet 124, such information could also be provided to users 140 through a variety of other personal communication devices such as pagers, facsimile machines, telephones, or cell phones. Additionally, users 140 may contact vessel monitoring unit 10 via the internet 124 to request information about his marine vessel.

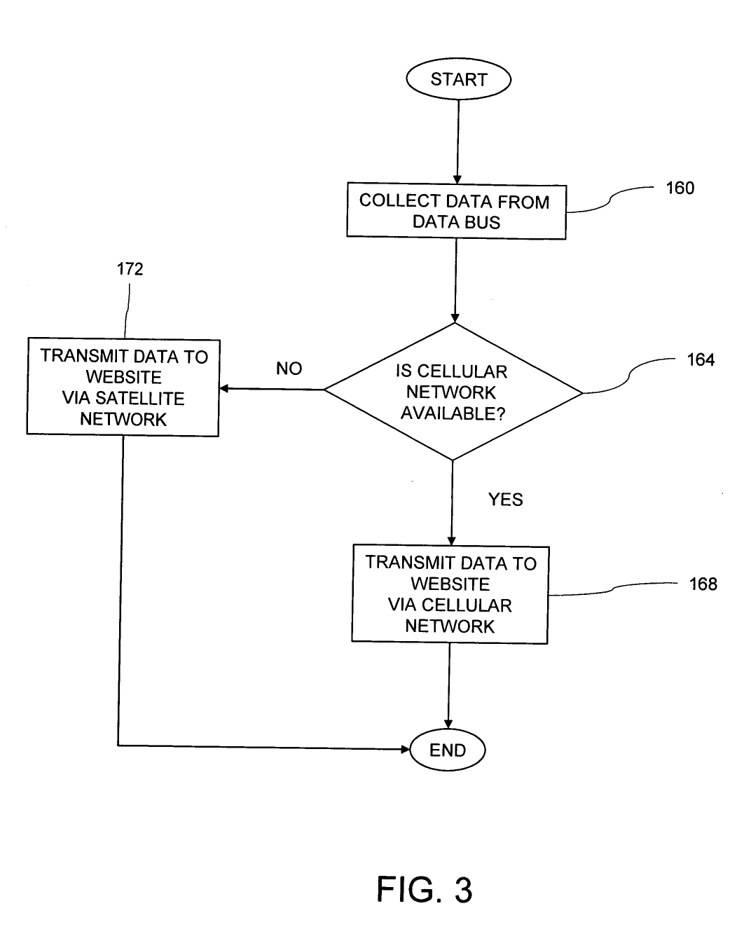

FIG. 3 is a method of monitoring the marine vessel. At act 160 data is collected from a data bus located on the vessel. At query 164, it is determined whether a cellular network is available for transmitting data. At act 168, data is transmitted to a website via the cellular network. At act 172, data is transmitted to a website via a satellite network if the cellular network is not available.

If the marine vessel is equipped with an external monitoring unit such as a Faria Gateway, or Faria MG2000, the external monitoring unit connects to and monitors the vehicle data bus and local inputs, either analog or switched. Data received from these inputs is supplied to various microprocessors in the external monitoring unit. The program in the microprocessors of the external monitoring unit scans the data received looking for information that has been defined as being the data that the system displays or forwards. When applicable information is detected, it is translated, using various algorithms, from its native format into the proprietary Faria Bus protocol. Depending on the intended use of the information, it may be translated into: characters for display on a display 82; digital information for operating a stepper motor to drive a pointer on a gauge; digital format for forwarding to the marine vessel monitoring system 10 for transmittal to a website 136.

Warning or diagnostic data from the marine vessel data bus and/or the external monitoring unit and various monitored and converted analog inputs that have been predetermined to be forwarded to the marine vessel monitoring system 10 is translated into digital data in a protocol for satellite messaging system. In order to minimize satellite message time, the format provides a code which translates the information into brief bursts of data. Each warning/diagnostic message only takes one bit in the data stream. Using the code, the marine vessel monitoring system 10 can transmit the data via the cell phone module 14 or the satellite modem 34 to the internet and a website or other messaging device which will recreate the warning/diagnostic message for an end user. The satellite messaging system description is applicable to any other end user system once the translation code is exchanged and the end user application set up.

The disclosed marine vessel monitoring system can provide continuous “bilge pump monitoring”. Using current monitoring methods known to the industry, the unit measures the amount of time the bilge pump operates. The data is sent via the satellite modem or cellular network to the internet and a website. Using an algorithm appropriate to the vessel being monitored, the unit determines if the bilge pump is operating normally or abnormally. If abnormal operation is detected, a message is sent to warn the owner/operator of this condition. Methods of contact include email, pager, cell phone, or fax. This continuous monitoring method can also be used for other run-time devices installed on a marine vessel, such as refrigeration.

The marine vessel monitoring system 10 provides an input that an operator can activate to notify appropriate authorities of an emergency condition. Depending on the vessel/vehicle in the situation, the message may be sent to the Coast Guard, police, or other appropriate authority. The message may consist of location information, derived from the GPS receiver 26, and a request for emergency assistance. Depending on location, the message can be sent by cellular network or satellite network. Methods of contact include email, pager, cell phone, or fax as previously established by the end user.

When an emergency message has been successfully received by an appropriate authority, the appropriate authority is then requested to generate a return message which is sent back to the marine vessel monitoring system 10, using appropriate technology indicating that the message has been successfully received. The marine vessel monitoring system 10 provides a visual indication of successful reception on an appropriate display device on the vehicle.

An interested party such as an engine manufacturer or a vehicle manufacturer may have a web based site established to receive the warning/diagnostic data sent from the marine vessel monitoring system 10. Using appropriate algorithms, statistical or other methods can be used to monitor a particular engine/vehicle's status and reported issues. The site can be set up to monitor a type of vehicle or engine for example, all vehicles/engines from that manufacturer, or a particular vehicle/engine. As the data is sent as it occurs, this can provide an early indication of a problem in a particular type of vehicle/engine, etc. before dealer or other source information may become apparent.

A major advantage of remote marine monitoring system 10 is the ability to view statistics about a marine vessel via the marine vessel monitoring system 10 on a web site 136 or alternatively through a personal communication device at any time from any location in the world. Another major advantage is that a boat owner can use the internet 124 to request the status of monitored functions on the owner's vessel.

In addition, a boat owner 140 can remotely change information displayed on the web site 136, set variable parameters and alter reporting periods. This allows boat owner 140 to monitor a marine vessel from anywhere in the world without having to subscribe to a third-party monitoring service or hire someone to check marine vessel periodically.

To facilitate remote monitoring and command execution, the web site 136 may consist of reverse channel software and forward channel software. The reverse channel software can receive status reports from the marine vessel monitoring system 10. It then loads this data into a database and logs all data to a backup file. Both the reverse channel software and forward channel software can ping the marine vessel monitoring system 10 on a periodic basis to verify connection and automatically attempt to reconnect if necessary.

Although the above described invention has been described with respect to marine vessels, the above described embodiments may be modified for other vehicles, including cars, trucks, recreational vehicles, and air planes.

It should be noted that the terms “first”, “second”, and “third”, and the like may be used herein to modify elements performing similar and/or analogous functions. These modifiers do not imply a spatial, sequential, or hierarchical order to the modified elements unless specifically stated.

While the disclosure has been described with reference to several embodiments, it will be understood by those skilled in the art that various changes may be made and equivalents may be substituted for elements thereof without departing from the scope of the disclosure. In addition, many modifications may be made to adapt a particular situation or material to the teachings of the disclosure without departing from the essential scope thereof. Therefore, it is intended that the disclosure not be limited to the particular embodiments disclosed as the best mode contemplated for carrying out this disclosure, but that the disclosure will include all embodiments falling within the scope of the appended claims

What is claimed is:

1. A system for monitoring conditions of a marine vessel, the system comprising:
a monitoring enclosure; the monitoring enclosure comprising:
a monitoring device circuit board;
a cell phone module in communication with the monitoring device circuit board;
a GPS receiver in communication with the monitoring device circuit board, and the cell phone module;
a satellite modem in communication with the monitoring device circuit board, the GPS receiver, and the cell phone module;
a bus input in communication with the monitoring device circuit board, and configurable to be in communication with a marine vessel data bus; and
wherein the monitoring enclosure is configurable to be in communication with an internet and provide marine vessel operating conditions to a website.

2. The system of claim 1, where the monitoring enclosure further comprises:
a user operated emergency switch; and
a display configurable to indicate that an emergency signal was received.

3. The system of claim 1, where the monitoring enclosure further comprises:
a satellite modem in communication with the GPS receiver; and
wherein the monitoring enclosure is further configurable to provide marine vessel operating conditions to a website using the satellite modem if a cellular network is not available.

4. The system of claim 1, where the website is configurable to receive data from a plurality of monitoring enclosures, and the website is configurable to tabulate data from devices made by a particular manufacturer.

5. The system of claim 4, wherein access to the data is restricted to the manufacturer.

6. The system of claim 1, where the website is configurable to receive data from a user's marine vessel, and displays the data on a website.

7. The system of claim 6, wherein access to the data is restricted to the user.

8. The system of claim 1, where the monitoring enclosure further comprises:
an operator interface;
an operator control unit in communication with the operator interface and the monitoring device circuit board; and
wherein the operator control unit is configurable to display marine vessel operation data from the marine vessel data bus.

9. The system of claim 8, wherein the operator control unit is further configured to display alarms from data obtained by the cell phone module or additional microprocessor.

10. The system of claim 8, wherein the operator control unit is further configured to display alarms from data obtained by a microprocessor in communication with an external monitoring unit.

11. The system of claim 1, where the monitoring enclosure further comprises:
an analog input in communication with the monitoring device circuit board and cell phone module, and wherein the analog input is configurable to be in communication with a current monitoring bilge pump monitor;
and wherein a user may be notified of a bilge pump alarm via a means selected from the group comprising website, email, pager, cell phone, fax, and telephone.

12. The system of claim 11, wherein the analog input is also in communication with a microprocessor in communication with an external monitoring unit.

13. The system of claim 1 1, where the monitoring enclosure further comprises:
an emergency input operable by a user;
wherein the emergency input is configurable to cause an emergency signal to be sent to an appropriate authority.

14. The system of claim 13, wherein the emergency input is further configurable to provide a one button push input.

15. The system of claim 13, wherein the monitoring enclosure is configurable to provide an emergency signal successfully received notification if the emergency signal was successfully received.

16. A method of transmitting operating conditions of a marine vessel comprising:
collecting data from a data bus;
determining whether a cellular network is available;
transmitting data to a website via the cellular network, if it is determined that a cellular network is available; and
transmitting data to a website via a satellite network, if it is determined that a cellular network is not available.

17. A system of monitoring conditions of a marine vessel comprising:
a marine vessel data bus;
a monitoring enclosure located on the marine vessel and in communication with the marine vessel data bus;
an internet in communication with the monitoring enclosure;
a website in communication with the internet, configured to store data from the monitoring enclosure; and
wherein the monitoring enclosure is in communication with the internet via a means selected from the group comprising a cellular network and a satellite network.

18. The system of claim 17, further comprising:
at least one other monitoring enclosure located on at least one other marine vessel; and
wherein the website is further configured to tabulate data for a plurality of equipment from a manufacture.
